(19) United States
(12) Patent Application Publication
(10) Pub. No.: US 2012/0202048 A1
(43) Pub. Date: Aug. 9, 2012

(54) METHOD OF SEALING AND SPACING PLANAR EMISSIVE DEVICES

(76) Inventors: WALTER E. MASON, ALFRED, NY (US); JEFFRY M. BULSON, HOPEWELL JUNCTION, NY (US)

(21) Appl. No.: 13/349,426

(22) Filed: Jan. 12, 2012

Related U.S. Application Data
(60) Provisional application No. 61/432,374, filed on Jan. 13, 2011.

(51) Int. Cl. B32B 5/16; B29C 65/52

(52) U.S. Cl. 428/323; 156/309.6

(57) ABSTRACT

A method of forming a planar emissive device, such as a flat fluorescent lamp or plasma display panel, including the steps of applying a frit paste including spherical spacers onto a broad face of a first planar substrate; setting the frit paste; coupling a second planar substrate to the frit paste; and flowing the frit paste to form a seal between the first and second substrate, wherein the gap size between the first and second substrate is substantially defined by the spacer diameter.

### CROSS-REFERENCE TO RELATED APPLICATIONS

This application claims the benefit of U.S. Provisional Application No. 61/432,374, filed Jan. 13, 2011, which is incorporated in its entirety by this reference.

### TECHNICAL FIELD

This invention relates generally to the planar emissive device field, and more specifically to a new and useful method of sealing and maintaining the discharge gap in the planar emissive device field.

### BACKGROUND

Flat fluorescent lamps and emissive displays are planar “light bulbs” that produce light over their entire surface area. Many operate as dielectric barrier discharge devices, which are constructed of two sheets of glass with external or dielectric-encapsulated internal planar electrodes that are used to produce a plasma discharge. This discharge takes place in a gas environment such as neon and/or xenon. If the device is being used to produce visible radiation, a phosphor may be deposited on the inside surfaces of the device. The plasma is typically energized by a high voltage applied to the electrodes, which produces a breakdown in the gas. In a dielectric barrier discharge device, the discharge is current limited by the insulating characteristics of the dielectrics that prevent the formation of an arc. The internal dielectric walls of the device develop a “wall charge” that reduces the breakdown voltage for subsequent discharges. Because of the shape of the device and the electrodes, the gap between the walls is critical to maintain the uniformity of the breakdown voltage and the resultant emitting plasma discharge. The breakdown electric field is a property of the gas and the geometry of the system, and it is more uniform if the discharge gap is constant over the entire area of the device.

The gap may be maintained in the internal areas of the device (away from the perimeter of the device) with a dielectric-encapsulated aluminum mesh spacer, with individual glass spacers, or with spacers molded into the front or back substrate glass. The gap may also be maintained at the perimeter of the device, which must also maintain the seal. The perimeter is generally fabricated by applying a frit paste to both sides of a glass spacer. The commercial frit paste is dried and then flowed at high temperature to produce a thin seal on both sides of the spacer. The spacer is typically pre-shaped to the final seal shape. As shown in FIG. 1A, in one conventional technique in the art, a single piece glass spacer 162 with a central hole for the active area is used. These spacers are expensive, but the device assembly is not labor intensive. As shown in FIG. 1B, another conventional technique in the art uses a seal spacer 164 with four separate pieces of glass to form each of the four sides of the device perimeter. These spacers are inexpensive, but the four corners are prone to leaking and the fabrication process is very labor intensive.

Additionally, early versions of flat fluorescent lamps used a lead sealing glass that flowed to form the seal at a relatively low temperature. However, these lead sealing glasses are toxic and are currently banned in many countries. Most of the replacements for lead sealing glasses typically have higher flow temperatures, which require higher process temperatures to achieve the same seal. Unfortunately, these higher temperatures tend to have adverse effects on other lamp-manufacturing processes and glass substrates.

Thus, there exists a need for an easy, low-temperature method of creating a leak-free, gap-maintaining seal.

### BRIEF DESCRIPTION OF THE FIGURES

FIG. 1 is a schematic representation of a first and second spacing method, respectively, of the conventional techniques in the art.

FIG. 2 is a flow diagram of the steps of a preferred embodiment of the method for sealing and spacing planar emissive devices.

FIG. 3A, 3B, 3C, and 3D are schematic representations of the steps of the preferred embodiment of the method, including the steps of: extruding frit paste including spherical spacers on a first glass substrate, drying the frit paste, coupling a second glass substrate to the first glass substrate, and flowing the frit paste, respectively.

FIGS. 4A and 4B are schematic representations of the original and final gap distances, respectively.

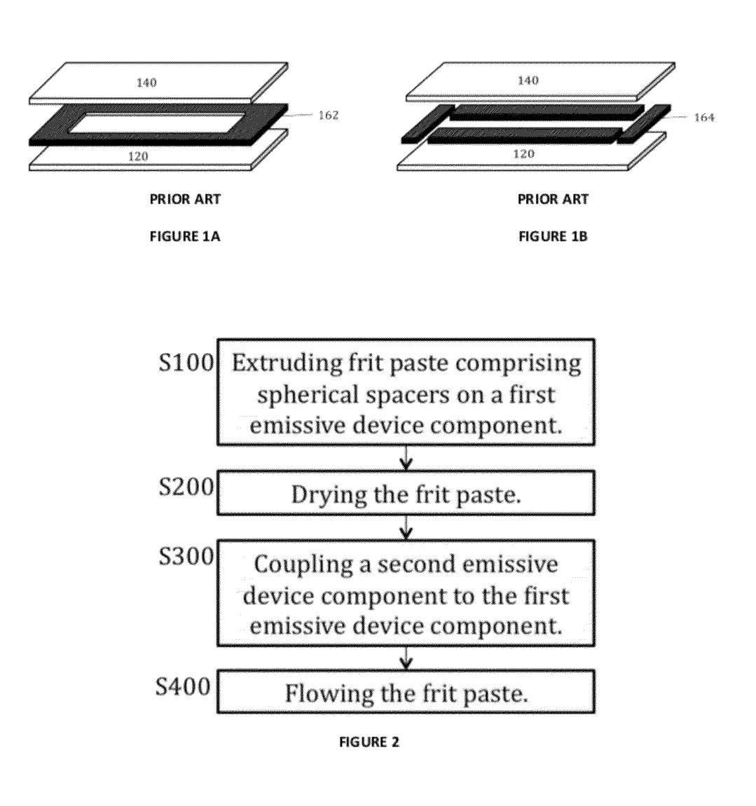

### DESCRIPTION OF THE PREFERRED EMBODIMENTS

The following description of the preferred embodiments of the invention is not intended to limit the invention to these preferred embodiments, but rather to enable any person skilled in the art to make and use this invention.

As shown in FIG. 2, the preferred embodiment of the method for sealing and spacing planar emissive devices, such as flat fluorescent lamps and plasma display panels, comprises the steps of extruding frit paste with incorporated spherical spacers on a first glass substrate S100, drying the frit paste S200, coupling a second glass substrate to the first glass substrate S300, and flowing the frit paste S400. This method is preferably used to create a hermetic seal between a first and a second glass substrate (120 and 140, respectively), wherein the seal is substantially the height of the spherical spacer 220 and substantially traces the perimeter of the first and second glass substrates. By mixing the spacers 220 into the frit paste 200, this method presents several potential advantages over the previously-mentioned conventional techniques. Firstly, the method is faster and less labor-intensive, since the spacers 220 do not require alignment, and the alignment does not have to be maintained throughout the sealing process. Secondly, the method minimizes leaking by mixing the spacers 220 into the frit paste 200 and ensuring that the frit paste 200 is applied about the entire emissive device perimeter. Instead of essentially “gluing” the spacers 220 to the glass substrates as seen in conventional techniques, this method cements the emissive device pieces together, wherein the emissive device gap is determined by the dimension of the glass spheres, which preferably have the largest dimension in the frit paste mix 200 (the spherical spacer 220). Thirdly, due to the composition of the frit paste and the relatively high aspect ratio (height-to-width ratio) of the applied frit paste bead 200, the sealing temperature used in this method may be lower than conventional sealing temperatures, reducing the issues associated with high sealing temperatures.

The step of extruding frit paste including spherical spacers on a first glass substrate S100 functions to apply the frit paste 200 to a glass substrate in a sealing pattern. The first glass substrate 120 is preferably a piece of planar glass, and may additionally and/or alternatively include an external or internal electrode and/or dielectric layer. The frit paste 200 is preferably a substantially homogeneous mix of spherical spacers 220, frit glass 240, and a vehicle including: a CTE additive, a binder, and a solvent. The frit paste 200 may additionally include a deflocculant to allow an increased solids content of the paste. The spherical spacers 220 of the mix function to define the gap distance between the glass substrates 120 and 140 after flow, wherein the diameter of the spacer 220 substantially defines the gap distance. Since these spacers 220 can be manufactured to close tolerances, very accurate control over the gap distance uniformity can be achieved. The spacers 220 are preferably approximately 1 mm in diameter, but may be as large as 10 mm or even larger, or as small as 0.1 mm or even smaller in diameter. The spherical spacers 220 preferably have a similar coefficient of thermal expansion (CTE) as the substrate glass, have a higher dilatometric softening point than the frit glass, and wet to the balance of the frit paste material. The spherical spacers 220 are preferably glass spheres, but may alternately be dielectric-encapsulated aluminum, gel-filled glass spheres, or any other material satisfying the previously-mentioned parameters. The spacers preferably comprise 2.5 wt % of the frit paste 200, but may alternately comprise as low as 0.1 wt % or as high as 10 wt % of the frit paste mix 200. The frit glass 240 functions to bond the glass substrates together and to bond the glass substrates with the spacers 220. The frit glass 240 is preferably a micron-sized glass powder mix, and preferably has a lower melting point than the glass substrates (120 and 140) and spacers 220. The frit glass 240 is preferably bismuth-based, but may alternatively be lead-based or include any suitable composition. Typical frit glasses include Viox types V2211 and 2357. The CTE additive functions to lower the frit paste's coefficient of thermal expansion (CTE) to that of the glass substrate. Examples of possible CTE additives that may be added to the frit paste 200 include cordierite, lead titanate, spodumene, or any other glass CTE additive. The binder functions to hold the other frit paste 200 glass components together until the frit glass 240 begins to flow during the seal process. Examples of the binder include glues (e.g. polyvinyl alcohol or ethyl cellulose glue) and acrylic resins such as elvacite that burn off, preferably completely but alternatively partially, during the flow process without significant residue. The binder is mixed into the frit paste 200 to maintain the extruded shape. The solvent functions to present a liquid foundation in which to create the homogeneous frit paste mix 200. The solvent is preferably an organic solvent. Examples of solvents that may be used include IPA, acetone, toluene, terpineol, turpentine, or any other organic solvent. The frit paste mix 200 may additionally include a deflocculant, which allows an increased solids mass content of the frit paste 200. The deflocculant is typically of the stearic type, and is preferably a short chain polymer molecule. More preferably, the deflocculant is a low-molecular weight anionic polymer. Examples of deflocculants that may be incorporated into the frit paste 200 include polyphosphates, lignosulfonates, quebracho tannins and those commercially provided by companies such as the Lubrizol Corporation, but may alternately be any deflocculant.

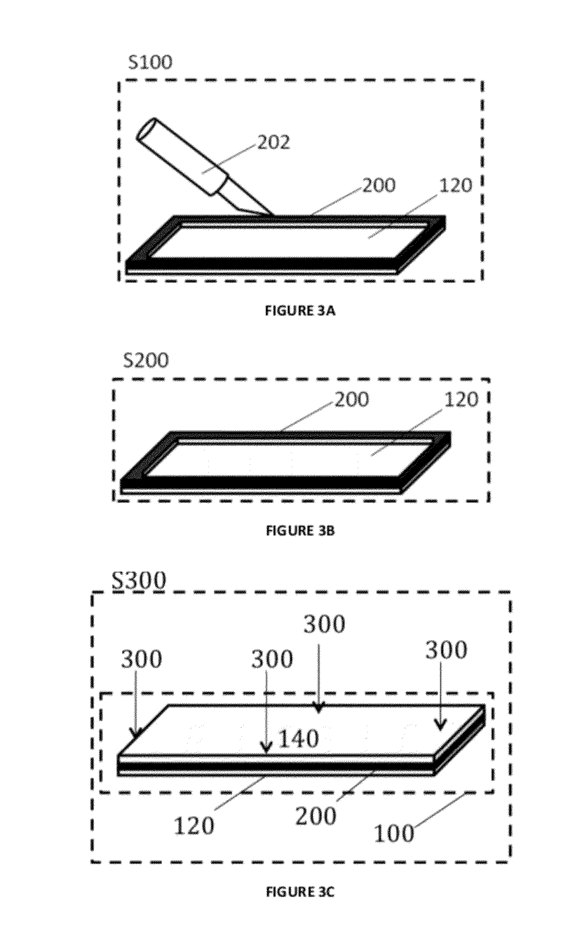

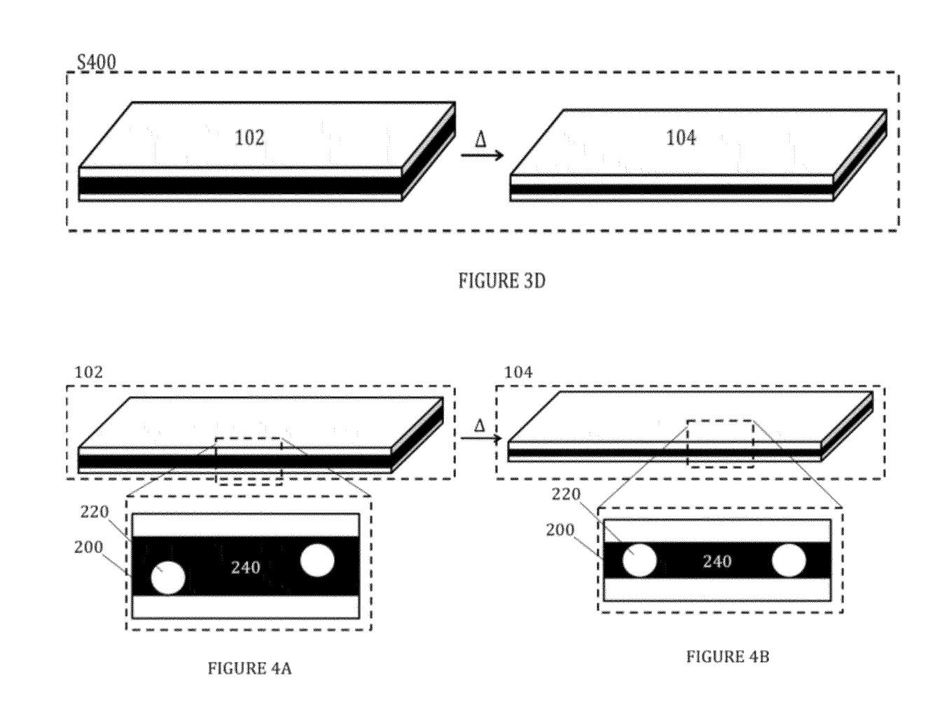

As shown in FIG. 3A, the frit paste 200 is preferably extruded about the perimeter of the first glass substrate 120 (on the interior surface) such that it substantially encircles the active area. However, the frit paste 200 may alternately be extruded onto the active area (area away from the perimeter) of the first glass substrate 120 in a mesh-like pattern. The paste is preferably extruded as an elongated strip, wherein the original aspect ratio (H:W) of the extruded strip cross-section is preferably approximately 1:1, which results in a final aspect ratio of 1:4 (0.25) after flow. However, the paste may be extruded in any shape with any dimension, but the final aspect ratio is preferably greater than or approximately 0.1. The height of the extruded paste varies according to the use. For example, for a frit paste 200 comprising 1 wt % spherical spacer 220, 65 wt % frit glass 240, 13 wt % CTE additive and binder, and 21 wt % solvent, the extruded height is preferably equal to or greater than two times the final height to accommodate the removal of porosity during flow. The extruded frit paste 200 height is preferably substantially uniform, but may vary. The frit paste 200 is extruded with a dispensing mechanism, wherein the dispensing mechanism preferably includes sphere aggregation-preventing geometry. For example, the paste may be extruded by a syringe 202, wherein the orifice of the syringe 202 is preferably two times the diameter of the spheres. The paste may alternately be pre-formed to the desired pre-flow dimensions using a mold and subsequently dried and inserted between substrates 120 and 140 before sealing. The frit paste 200 may also be printed onto the glass substrate, stamped onto the glass substrate, extruded from a tube, painted onto the glass substrate, or applied using any other method to achieve the desired pattern and geometry on the glass substrate.

As shown in FIG. 2, the step of drying the frit paste S200 functions to retain the shape of the extruded frit paste 200 until the frit paste 200 is flowed, as well as to preliminarily bond the frit paste 200 to the first glass substrate 120. This step preferably precedes step S300, but may alternately follow S300, in which case the frit paste 200 is preliminarily bonded to both the first and second glass substrates (120 and 140, respectively). The frit paste 200 is preferably dried in a low temperature drying oven to evaporate the solvent, but may alternately be dried at room temperature (shown in FIG. 3B) or in a desiccating chamber.

The step of coupling a second glass substrate to the first glass substrate S300 functions to introduce a gap-defining glass substrate to the emissive device, to maintain the desired relative positioning between the first and second glass substrates (120 and 140, respectively) during step S400, and to provide a substantially equally distributed force 300 over the plates. As shown in FIG. 3C, the second glass substrate 140 is preferably substantially identical to the first glass substrate 120, and is preferably a piece of planar glass that may include an external or internal electrode, dielectric layer, phosphor, electron emissive coating, and/or other materials and structures. The interior surface of the second glass substrate 140 is preferably coupled to the extruded frit paste 200, such that the second glass substrate 140 is substantially parallel to the first glass substrate 120. The assembly 100 (the first and second glass substrates with the extruded frit paste 200) is preferably coupled by clamping the first and second glass substrates (120 and 140, respectively) together around the perimeter, but may alternately be coupled by applying a weight to the assembly 100 or by applying a clamping force 300 to substantially the whole of the first and second glass substrates' perimeter. The coupling force 300 is preferably applied perpendicular to the substrates' broad faces to minimize seal distortion during step S400.

As shown in FIG. 2, the step of flowing the frit paste S400 functions to create the seal and to achieve the desired gap size. This step preferably occurs after S300, but may alternately occur before S300, wherein the second glass substrate is lowered onto the dried frit paste as the frit paste is melting. In this step, heat is applied to soften and melt the frit glass 240, causing the frit glass 240 to bond with both the glass substrates and spacers 220, substantially creating a leak-free seal. Because the spacers 220 are interspersed within the frit paste 200, the seal does not suffer from misalignments between the spacers 220 that cause leaking gaps, as seen in conventional techniques. Furthermore, the high aspect ratio of the frit paste 200, in combination with the frit paste formulation and the applied coupling force 300, functions to allow the frit to flow at a lower temperature than standard bismuth frit flow temperatures. In this step, the first and second glass substrates start at the original extrusion distance (shown as the original assembly 102 in FIGS. 3D and 4A), and are pushed towards each other (by the coupling force 300, the weight of the glass substrates, and/or externally applied weights) as the frit material softens and flows, eventually arriving at the final gap distance (as defined by the diameter of the spacers 220), seen in the final assembly 104 (shown in FIGS. 3D and 4B). Throughout this step, the first and second glass substrates (120 and 140, respectively) advance until they substantially contact opposing surfaces of the spacers 220. This step is preferably accomplished in a sealing oven, but may alternately be accomplished with a heat gun, a heater, or any other heating device that may provide a controlled, evenly distributed temperature. This step is preferably performed at the dilatometric softening point of the frit glass, which is typically 100° C. lower than conventional sealing temperatures. However, this step may be performed at a temperature slightly higher or significantly higher than the dilatometric softening point of the frit glass. Examples of flow temperatures include 500° C., 520° C. and 550° C., but other flow temperatures may be used. Furthermore, this step is preferably performed at atmospheric pressure, but may alternately be performed in a vacuum, pressurized chamber, or gas purged environment.

The method may additionally include the step of introducing an ionizable gas into the emissive device. The ionizable gas is preferably a mixture of noble gasses, but may alternatively be any suitable gas mixture. The ionizable gas is preferably introduced after the emissive device is sealed, but may alternatively be introduced before or during emissive device sealing. For example, the gas may be introduced into the emissive device during or directly after the second substrate is coupled to the first, or emissive device sealing may be performed in a chamber filled with the gas mixture. However, the ionizable gas is preferably introduced into the cavity of the sealed emissive device through an opening in the first or second substrate (120 and 140, respectively), more preferably an opening in a broad face of the first or second substrate. The gas is preferably introduced through a tube inserted into the opening, wherein the tube may include a seal that prevents gas leakage, but may alternatively be introduced by placing the emissive device into a chamber pressurized with the gas, or by any other suitable method. The method may additionally include the step of sealing the substrate opening, preferably by locally applying heat to the tube to collapse the tube, thereby sealing the opening, and removing excess tubing from the encapsulated emissive device/tube assembly. Alternate methods may include applying and curing a seal material within the opening, wherein the curing temperature of the seal material is preferably lower than the dilatometric softening point of the frit glass. Examples of seal material include glass, ceramic, polymer (e.g. epoxy), solder, or any other suitable material. However, the opening may be sealed with a plug or any other suitable means.

As a person skilled in the art will recognize from the previous detailed description and from the figures and claims, modifications and changes can be made to the preferred embodiments of the invention without departing from the scope of this invention defined in the following claims.

We claim:

1. A method of forming a planar emissive device, comprising the steps of:
a. applying a frit paste including spherical spacers onto a broad face of a first planar substrate;
b. setting the frit paste;
c. coupling a second planar substrate to the frit paste; and
d. flowing the frit paste to form a seal between the first and second substrate, wherein the gap size between the first and second substrate is substantially defined by the spacer diameter.

2. The method of claim 1, wherein step a) comprises extruding the frit paste onto the first substrate.

3. The method of claim 1, wherein step a) comprises applying the frit paste in a substantially continuous strip along the perimeter of the broad face of the first planar substrate.

4. The method of claim 3, wherein the aspect ratio of the strip is approximately 1.0.

5. The method of claim 1, wherein step b) comprises drying the frit paste.

6. The method of claim 1, wherein step b) precedes step c).

7. The method of claim 1, wherein step c) comprises coupling the broad face of the second planar substrate to the frit paste.

8. The method of claim 7, wherein step c) further comprises the sub-steps of:
aligning the second substrate with the first substrate; and,
compressing the broad face of the second substrate towards the first substrate.

9. The method of claim 8, wherein the compressive force is applied perpendicular to the broad face of the substrates.

10. The method of claim 8, wherein the first and second substrates are substantially identical prismatic plates, wherein aligning the substrates comprises aligning the edges of the first and second substrates.

11. The method of claim 1, wherein step d) further comprises compressing the second substrate towards the first substrate during frit paste flow.

12. The method of claim 1, wherein the gap size of step d) is substantially equivalent to the sphere diameter.

13. The method of claim 1, wherein the spacers comprise 0.1 to 10 weight percent of the frit paste.

14. The method of claim 1, wherein the spacers are glass spheres.

15. The method of claim 1, wherein the frit paste further comprises frit glass.

16. The method of claim 15, wherein the spacers have a coefficient of thermal expansion similar to that of the first substrate and a dilatometric softening point higher than the frit glass.

17. The method of claim 16, wherein step d) comprises heating the frit paste to the dilatometric softening point of the frit glass.

18. The method of claim 15, wherein the frit paste further comprises: binder, solvent, and CTE additive that adjusts the coefficient of thermal expansion of the frit paste to approximate that of the first substrate.

19. The method of claim 18, wherein the frit paste additionally comprises a deflocculant.

20. A planar emissive device made by the method of claim 1.
